(19) United States
(12) Patent Application Publication
(10) Pub. No.: US 2025/0078306 A1
(43) Pub. Date: Mar. 6, 2025

(54) NAVIGATION MAPPING METHOD FOR CONSTRUCTING EXTERNAL IMAGES OF MACHINE

(71) Applicant: Shenzhen Seauto Technology Co., Ltd., Shenzhen (CN)

(72) Inventor: ZHUOMING DENG, Shenzhen (CN)

(21) Appl. No.: 18/560,920

(22) PCT Filed: Jul. 23, 2023
(86) PCT No.: PCT/CN2023/108771

§ 371 Date: Nov. 14, 2023

(30) Foreign Application Priority Data
May 8, 2023 (CN) 202310507992.6

(51) Int. Cl. G06T 7/70; G06T 1/00; G06T 7/00; G06V 10/80

(52) U.S. Cl. CPC G06T 7/70; G06T 1/0014; G06T 7/97; G06V 10/803

(57) ABSTRACT

The present disclosure relates to the field of navigation mapping, specifically, to a navigation mapping method for constructing external images of a machine. The method comprising: taking photos facing a target area by covering the target area, so as to obtain a 2D image outside the machine, converting a colored 2D image into a 2D image with only “0” and “1” pixel values; identifying a coverage of machine in the 2D image, determining a position of machine in the 2D image based on the coverage. In the present disclosure, a top view of the 2D image outside the machine can be obtained, if the machine is in the target area, the obtained 2D image includes a top view of the machine, a location of machine can be determined through the top view, whether the machine or obstacles in the target area, they can be intuitively displayed in the 2D image.

### TECHNICAL FIELD

The present disclosure relates to the field of navigation mapping, and specifically, to a navigation mapping method for constructing external images of a machine.

### BACKGROUND

Currently, robots on the market generally have a function of photo recognition, and can avoid obstacles timely, for example, water surface cleaning robots in swimming pools or lawn mowing robots on lawns, all of the sensors of the robots are set on the machines. However, in actual use, since there are fewer characteristics in swimming pools and lawns, and the height of the sensors are affected by the height of the robots. As such, the range of photos that can be obtained is small, and there may be few characteristics. Therefore, the pictures obtained by setting the sensors in the above described configuration may be difficult for machines to identify the location, resulting difficulties in navigation methods to avoid obstacles in practical applications.

Although positioning method and radars can be used to effectively avoid obstacles, both the Beidou positioning system and the determination of radars have certain limitations, especially for water surface cleaning robots or lawn mowing robots, because these types of the robots have a target area for them work, it only works within the target area, and the boundary radar of the target area cannot detect, positioning can only determine a position of one point, and the image outside the robot cannot be intuitively displayed, thus both of them have certain disadvantages.

### SUMMARY OF DISCLOSURE

The present disclosure provides a navigation mapping method for constructing external images of a machine for solving the problems which are raised in the above background.

A navigation mapping method for constructing external images of a machine is provided, the method comprising: obtaining real-time images of a target area, processing the real-time images and obtaining a two dimensional (2D) image of the target area, based on a coverage of the machine in the 2D image, obtaining real-time positions of the machine in the target area.

As a further improvement of the technical solution, the acquisition of the real-time images and the real-time positions includes the following steps, S1: at time T, taking photos facing the target area by covering the target area, so as to obtain a real-time image outside the machine at the time T, S2: processing the real-time image at the time T to obtain a 2D image, S3: identifying a coverage of the machine in the 2D image at the time T, and determining a position of the machine in the 2D image at the time T based on the coverage, S4: after t time, obtaining the following equation: T=T+t, and repeating S1 to S4.

As a further improvement of the technical solution, the processing for the real-time images in S2 includes a binarization operation, and the binarization operation comprises: obtaining a grayscale threshold, based on the grayscale threshold, determining each pixel point of the real-time image, if the grayscale value of the pixel point is greater than the grayscale threshold, setting the grayscale value of the pixel point to one (1), and if the grayscale value of the pixel point is less than the grayscale threshold, setting the grayscale value of the pixel point to zero (0).

As a further improvement of the technical solution, in the 2D image, an area with the grayscale value “0” of the pixel point is determined as the machine-walkable area, and an area with the grayscale value “1” of the pixel point is determined as the machine-unwalkable area.

As a further improvement of the technical solution, in S4, recording the position of the machine in the 2D image obtained every time, and establishing a coordinate system, including, setting a coordinate origin in the 2D image and establishing a coordinate system based on the coordinate origin, and on the coordinate system, recording coordinates of specific points on the coverage of the machine.

As a further improvement of this technical solution, speed computing formulas of the machine in the coordinate system are as follows:

$$P ( x , y ) ;$$

$${v}_{x} = \frac{( {x}_{T + t} - {x}_{T} )}{t} ;$$

$${v}_{y} = \frac{( {y}_{T + t} - {y}_{T} )}{t} ,$$

wherein P(x,y) is the coordinate recording in the coordinate system of a specific points, vₓ is the speed on the x-axis of the specific point within a time t, v_{y} is the speed on the y-axis of the specific point within the time t, x_{T+t} is the abscissa of the specific point after the time t, x_{T} is the abscissa of the specific point before the time t, y_{T+t} is the ordinate of the specific point after the time t; y_{T} is the ordinate of the specific point before the time t.

As a further improvement of the technical solution, in S1, taking photos of the target area by using one or more cameras, wherein the one or more the cameras are set, so that the photographed area obtained by photographing covers the target area.

As a further improvement of the technical solution, obtaining the real-images by using at least two cameras, and the at least two cameras are mounted at a high point of the target area; the photographing height of the plurality of cameras are the same, the plurality of cameras form photographing areas by photographing, and each photographing area comprises at least one other photographing area for forming an intersection area with the photographing area, fusing the photographing areas based on the intersection area to obtain the 2D image.

As a further improvement of the technical solution, obtaining the real-time images by using at least three cameras, and selecting at least one of the at least three cameras as a high-mounted camera, a high-mounted photographing area formed by photographing with the high-mounted camera forms an intersection area with other photographing areas respectively, and a combination of the other photographing areas can cover all of the target area, fusing the photographing areas based on the intersection area to obtain the 2D image.

As a further improvement of the technical solution, fusing the photographing areas according to a multi-view image fusion algorithm, and a formula of the multi-view image fusion algorithm is as follows:

$$[ \begin{matrix}{x}_{i} \\ {y}_{i} \\ 1\end{matrix} ] = F [ \begin{matrix}{x}_{j} \\ {y}_{j} \\ 1\end{matrix} ] ,$$

wherein xᵢ and xⱼ are respectively an abscissa coordinate of a feature point of two photographing areas in the intersection area, yᵢ and yⱼ are respectively an ordinate coordinate of the feature point of the two photographing areas in the intersection area, F is a basic matrix from a photographing area to another photographing area.

Compared with the prior art, the beneficial effects of the present disclosure are as follows: in the navigation mapping method of constructing the external images of the machine, a top view 2D image outside the machine can be obtained, if the machine is in the target area, the 2D image obtained by photographing at this time includes a top view of the machine, in this way, it can determine the location of the machine through the top view image, whether the machine or the obstacles in the target area, they can be intuitively displayed in the 2D image. More importantly, the machine changes its position in the 2D image as a two-dimensional image, it makes the determination of its position more intuitive, especially at the boundary. Furthermore, since the sensor is not set on the machine, the obtained 2D image is not limited by the machine itself, and the obtained view of the 2D image becomes wider.

### BRIEF DESCRIPTION OF THE DRAWINGS

FIG. 1 is a schematic flowchart of a method of the present disclosure.

FIG. 2 is a schematic flowchart of steps of binarization operations of the present disclosure.

FIG. 3 is a schematic diagram of a photographing area under a camera of the present disclosure.

FIG. 4 is a schematic diagram of the photographing area under two cameras of the present disclosure.

FIG. 5 is a schematic diagram of a fusion principle of two photographing areas of the present disclosure.

FIG. 6 is a schematic diagram of a high-mounted photographing area of a high-mounted camera of the present disclosure.

FIG. 7 is a schematic diagram of a target area determination principle of the present disclosure.

FIG. 8 is a schematic diagram of a machine movement principle of the present disclosure.

### DESCRIPTION

The present disclosure is further described below with reference to the accompanying drawings and embodiments. The technical solutions in the implementations of the present disclosure will be clearly and completely described below with reference to the drawings in the implementations of the present disclosure. Obviously, the described implementations are only a part of the implementations of the present disclosure, rather than all the implementations. Based on the implementations of the present disclosure, all other implementations obtained by those ordinary skilled in the art without creative efforts fall within the scope of protection of the present disclosure.

Currently, robots on the market generally have the functions of photo recognition, and can avoid obstacles timely, for example, water surface cleaning robots in swimming pools or lawn mowing robots on lawns, the sensors of the robots are set on the machines. However, the characteristics on the swimming pools and the lawns are very similar, and the sensors are affected by the height of the robots, the viewable range of the photos obtained is very small, therefore, the pictures obtained in the above described configuration may be difficult for the machine to recognize, resulting difficulties in which makes the navigation methods to avoid obstacles in practical applications.

Therefore, a navigation mapping method for constructing external images of a machine is provided in the present disclosure, the method comprising: obtaining real-time images of a target area, processing the real-time images and obtaining a 2D image of the target area, based on a coverage of the machine in the 2D image, obtaining real-time positions of the machine in the target area.

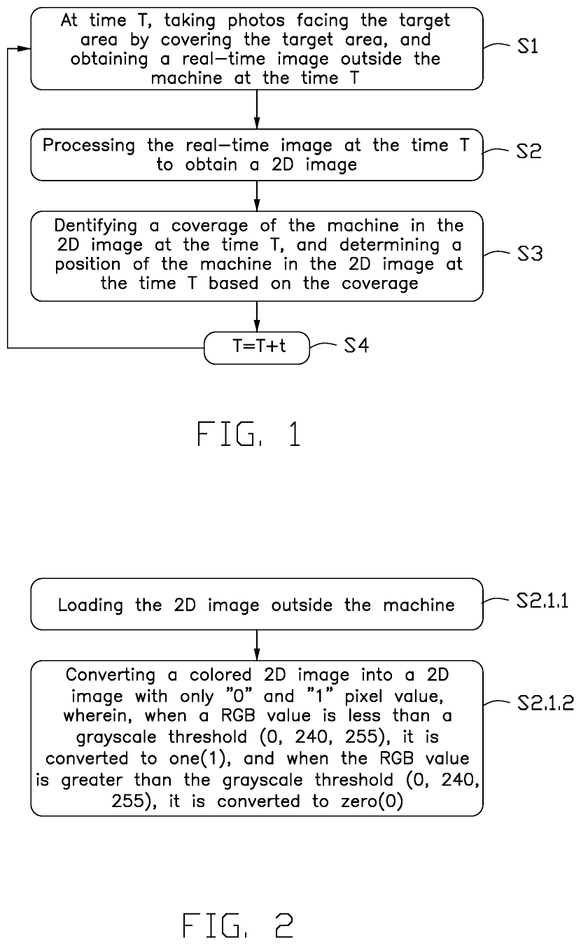

As illustrated in FIG. 1, the detailed steps of the mapping method comprising: firstly, setting a device for taking photos directly above a target area, the device can be an unmanned aerial vehicle equipped with a camera, or a camera can be set up above the target area, it is more convenient to use the unmanned aerial vehicle, but the stability is not high (it is easy to shake due to the weather, resulting in the obtained pictures by taking photos are blurry), therefore, it is suitable for indoor use, such as in swimming pools, directly setting up the camera is more cumbersome, and inflexible, greatly affected by space, because it is necessary to construct a bracket to connect the camera, but higher stability, so it is suitable for outdoor environments, such as on the lawns.

Then, performing S1, at time T, taking photos facing the target area by covering the target area, and obtaining a real-time image by taking photos, specifically, using a camera to implement a photographing operation, to obtain a 2D image outside the machine (i.e., a robot or other machine which can move by itself, and can control the machine) at the time T, if only one camera is set, a limit of the time T only determines the time for taking photos, however, if a plurality of cameras are set, the limit of the time T can not only determine the time for taking photos, but also ensure that the 2D image captured by the cameras are at the same time, to achieve the purpose for controlling variables, and avoid differences in certain features in the 2D images obtained by different cameras due to different photography time.

It should be noted that because to obtain one 2D image on the ground, the camera is required to take photos by facing the target area, so that a top view 2D image of an object in the target area can be obtained.

In addition, there is no limit on the number of cameras, which will be determined based on the photographing requirements and actual usage. However, to ensure that the 2D images or a combination of the 2D images obtained by the camera by taking photos can cover the entire target area. Usually, the larger the target area, the greater the number of camera settings.

In S2, processing binarization operations for the 2D image at the T time, to convert a colored 2D image into the 2D image with only “0” and “1” pixel values (i.e., the grayscale value of the pixel, hereafter referred to as the pixel value), wherein, as illustrated in FIG. 2, the steps of the binarization operations for the 2D image areas follows: S2.1.1: loading the 2D image outside the machine, S2.1.1: converting a colored 2D image into the 2D image with only “0” and “1” pixel value, when a RGB value is less than a grayscale threshold (0, 240, 255), it is converted to 1, and when the RGB value is greater than the grayscale threshold (0, 240, 255), it is converted to 0.

In S3, identifying a coverage of the machine in the 2D image at the time T, and determining a position of the machine in the 2D image at the time T based on the coverage, namely, the point that determines the position has an area attribute, and the area attribute is determined based on the coverage of the machine.

Since it is necessary to track the machine, the above steps should be repeated, to obtain the changes in the machine position, therefore, finally processing S4, after t time, obtaining the following equation. T=T+t, and repeating S1 to S4, wherein the t is a photographing time interval of the camera, in one of the implementations, it is preferably controlled at a photographing frequency of 5 frames per second, that is, t=0.2 s.

Through the above steps, a top view of the 2D image outside the machine can be obtained, if the machine is in the target area, the 2D image obtained by photographing at this time includes a top view of the machine, it can determine the current position of the machine on the lawns or in the swimming pools through the top view image, and through the 2D image obtained by acquiring and processing, the obstacles in the machine and the target area can be intuitively displayed.

More importantly, the robot changes the position in the 2D images as a two-dimensional image, which makes the determination of its position more intuitive, especially at the boundary of the 2D image.

Moreover, since the sensor that collects the image is not set on the machine when obtaining the image, the 2D image obtained is not limited by the height of the machine itself, and the obtained view of the 2D image is more wider, in addition, it is not limited to the above-mentioned forms to obtain the 2D images, and other forms are illustrated by the following implementations.

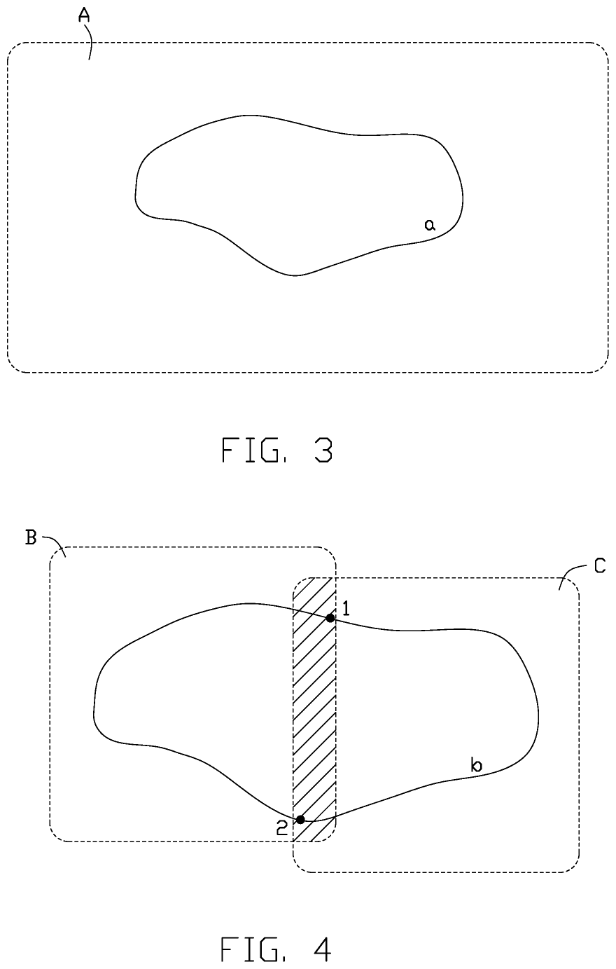

A first implementation, in the present implementation, setting one camera, through the one camera, the target area is directly captured, as illustrated in FIG. 3, A in the figure is the photographing area captured by the one camera, it can be seen that the photographing area A can cover the entire target area a, an advantage of this implementation method is that there is no need to consider the influence of variables, because one photographing area A, it can cover the entire target area a, and there is no need to fuse the photographing areas.

In the above implementation, when the target area a is small, one camera can be used to take photos, usually, using the camera with a medium angle of view, when the capturing height is less than 50 meters, the area of the lake that can be photographed can cover about 500 square meters, and less than 10 meters, an area of a lake that can be photographed can cover about 100 square meters, but considering that the position of the machine needs to be determined, this results in the scenarios that a camera can be used for taking photos are extremely limited.

A second implementation, setting at least two cameras to take photos for the target area, so that the photographed area can still cover the target area when reducing the capturing height, at this time, multiple photographing areas need to be fused, therefore, in the obtained photographing areas, each photographing area comprises at least one other photographing area for forming an intersection area with the photographing area; and fusing the photographing areas based on the intersection area.

Specifically, searching feature points in the intersection area, and then using the common feature points of the two photographed areas in the intersection area to fuse the both by a multi-view image fusion algorithm. A formula of the multi-view image fusion algorithm is as follows.

$$[ \begin{matrix}{x}_{i} \\ {y}_{i} \\ 1\end{matrix} ] = F [ \begin{matrix}{x}_{j} \\ {y}_{j} \\ 1\end{matrix} ] ,$$

Wherein xᵢ and xⱼ are respectively an abscissa coordinate of a feature point of two photographing areas in the intersection area, yᵢ and yⱼ are respectively an ordinate coordinate of the feature point of the two photographing areas in the intersection area, F is the basic matrix from a photographing area to another photographing area.

It is assumed that two cameras are set, and the heights of the cameras are the same, as illustrated in FIG. 4, because the heights are the same, so the same type of camera can obtain the same photographing area, the two cameras obtain the photographing area B and the photographing area C, if a single photographing area (i.e. the photographing area B or the photographing area C) cannot cover the target area b, but a combination of them can cover the target area b, selecting a feature point in an intersection area (i.e. the shaded part) of the photographing area B and the photographing area C, the more prominent selected feature point in the intersection area are better, this makes it easier to determine the coordinates of the feature point during fusion.

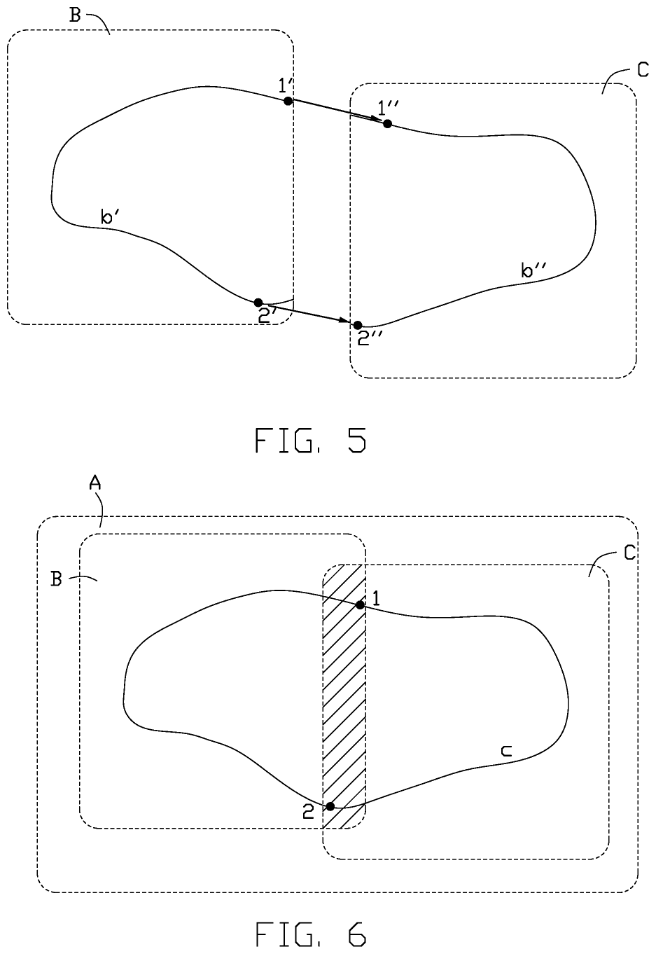

It is assumed that there are two coordinates of the determined feature points, respectively point 1 and point 2, and obtaining the coordinates (x₁,y₁) of the point 1 and the coordinates (x₂,y₂) of the point 2, and then fusing the photographing area B into the photographing area C, as illustrated in FIG. 5, point 1′ is fused with point 1″, point 2″ is fused with point 2″, and then obtaining the fusion of the target area b′ and the target area b″, after the fusion, obtaining the entire target area b.

Preferably, when taking photos, making the machine fall in an intersection area, so that the machine is in the photographed area, then using the machine as the basic feature point, and selecting other feature point around it, so that the machine itself is a significant feature, and then obtaining the feature point group according to its surrounding feature points, with the help of the machine, the surrounding feature points also have a certain significance, thus making the fused target area more accurate.

Moreover, the basic feature point can be used as an target of a shift parameters during fusion, and the remaining feature points can be used as an target of the rotation parameters, to ensure that the positioning of the photographed area during fusion is accurate, then ensuring the accuracy of the rotation through multiple feature points, even if a few feature points appear deviation, it will be corrected by other feature points.

However, if there is only one machine, only two cameras can be set, because one machine has only one position in the 2D image at the same time; if there are two machines, three cameras can be set; and so on to get the number of machines, and the number of machines is D, the number of cameras is D+1.

It should be noted that when setting more than two cameras, it is enough to fuse the photographing areas in pairs according to the above principle, which will not be described in detail here.

A third implementation, when the number of the setting cameras is three or more, selecting at least one camera as a high-mounted camera, the high-mounted photographing area formed by the photographing of the high-mounted camera intersects with other with other photographing areas, namely the photographing height of the high-mounted camera is higher than the photographing height of other cameras, and a combination of other photographing areas can cover the entire target area, so that a large photographing area can be obtained through a high-mounted camera.

As illustrated in FIG. 6, for considering the same feature point, there may be a certain difference in viewing angles due to changes of the photographing position. and in order to save the number of cameras, usually fusing the edges of the photographing area, the closer to the edge the viewing angle is, the difference will be more obvious, which cause that a deviation is appeared during fusion, in this implementation, setting a high-mounted cameras, and determining the feature points at the intersection of the photographing area A of the high-mounted camera and the intersection area, so that the feature points fall on the middle of the photographing area A, then correcting the feature points in the photographing area B and the photographing area C through the high-mounted photographing area A, to reduce the impact of the deviation of the viewing angle.

Moreover, the last fused areas are still the photographing areas B and C, therefore, it will not affect the presentation of the target area after fusion.

Not only that, there is another implementation method, because the camera covered by the high-mounted camera is included in the high-mounted photographing area obtained by the high-mounted camera, at this time, this feature is used as a verification to further improve the accuracy of the fused target area, especially when setting a plurality of high-mounted cameras, using these cameras as features to assist the photographing area covered by this high-mounted photographing area and the photographing areas covered by other high-mounted photographing areas to fuse.

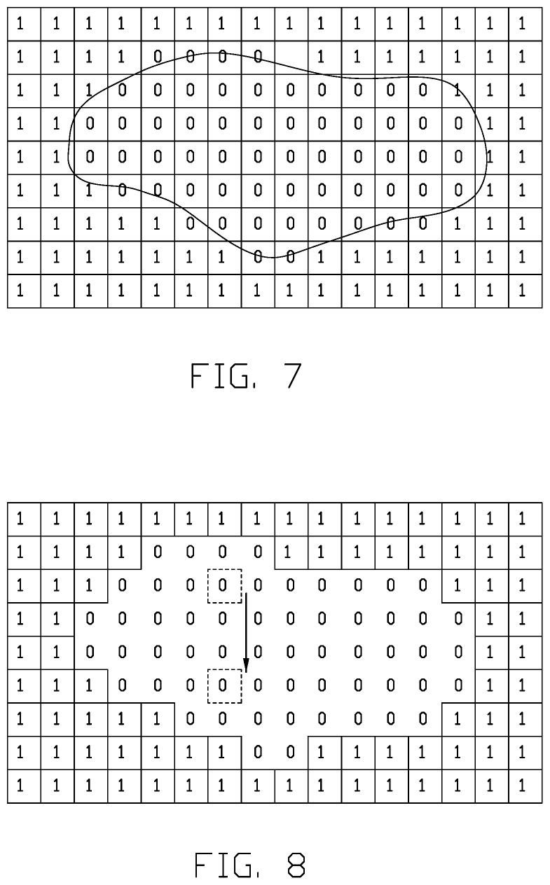

Based on the above implementations, setting the following application scenarios, firstly, as illustrated in FIG. 7, an area with a pixel value “0” is determined as the machine-walkable area, and an area with the pixel value “1” is determined as the machine-unwalkable area, referring to FIG. 8, a blank area is the machine-walkable area, and forming a boundary at the edge of the blank area, i.e., a dividing line between the “0” pixel block and the “1” pixel block of the outermost, it is assume that the floating objects on the water surface are salvaged in the swimming pool, at this time, the RGB pixel of the light blue water are (0, 240, 255), and then the original RGB image (i.e. color image) is converted into a grayscale image with only “0” and “1” pixels, when the RGB value is less than (0, 240, 255), it is converted into “1”, when the RGB value is greater than (0, 240, 255), it is converted to “0”.

According to the characteristics of the grayscale image, the pixel values of them are characterized by only “0” and “1”, and finding the largest “0” to connect the range of the target area, and finding left, right, up, and down boundaries respectively, and specifying this area as the area for the machine walking range.

Recording obtained positions of the machine in the 2D image every time, and establishing a coordinate system, recording coordinates of a specific point on the coverage of machine, it is known that a length of the straight line passing through the specific point perpendicular to the direction of the machine movement on the coverage surface, so that it makes easy to calculate the area swept by the machine and determine the external contour of the machine.

In addition, speed calculation formulas of the machine in the coordinate system are as follows:

$$P ( x , y ) ;$$

$${v}_{x} = \frac{( {x}_{T + t} - {x}_{T} )}{t} ;$$

$${v}_{y} = \frac{( {y}_{T + t} - {y}_{T} )}{t} ,$$

wherein P(x,y) is a coordinate recording in the coordinate system of a specific point, vₓ is a speed on a x-axis of the specific point within a time t, v_{y} is a speed on a y-axis of the specific point within the time t, x_{T+t} is a abscissa of the specific point after the time t, x_{T} is a abscissa of the specific point before the time t, y_{T+t} is a ordinate of the specific point after the time t; y_{T} is a ordinate of the specific point before the time t.

Identifying the machine in the target area, when the color of the machine is black, taking photos to obtaining a RGB pixel value (128, 128, 128), the water is light blue or colorless, which is quite different from the RGB of gray, and based on the RGB threshold (0, 240, 255) processing binarization in the target area and finding the four positions of the robot, the four positions are the bottom left coordinate (X5, Y5), the bottom right coordinate (X6, Y6), and the top left coordinate (X7, Y7), the top right coordinate is (X8, Y8).

Using a camera to capture 5 frames per second, so as to track the target, selecting a tracking scheme by two frames apart, recording a position of the first frame and a position of the second frame, wherein, positions of the four corners of the first frame, that are the positions of the above dashed boxes in FIG. 8, the bottom left coordinate (X5, Y5), the bottom right coordinate (X6, Y6), the top left coordinate (X7, Y7), and the top right coordinate is (X8, Y8) of the above dashed boxes, wherein, positions of the four corners of the second frame, that is the below dashed boxes, the bottom left coordinate (X9, Y9), the bottom right coordinate (X10, Y10), the top left coordinate (X11, Y11), and the top right coordinate is (X12, Y812) of the below dashed boxes, and then calculating the speed.

Finally, according to the current speed of the robot, the direction of the robot on the two frames of images is used to obtain whether the robot is heading towards the boundary, and then calculating the distance between the speed direction and the pixel point heading towards the boundary, when the robot is close to the pixel point of the boundary and the distance is fifteen (15), controlling the robot or performing other operations for the robot, to avoid obstacles, and navigate and plan the path of the robot.

It should be noted that for facilitating intuitively the observation of pixel blocks, the images are enlarged, in actual work, the more pixel blocks there are, the smoother the boundary of the displayed target area will be.

Preferably, setting a navigation light on an outside of the machine along its contour to make the machine more conspicuous, and the angle of the light emitted by the navigation light is not interfered by the medium, that is, the navigation light needs to be set above the water surface, so that the RGB values of the machine by photographing are (128, 128, 128).

In addition, the machine changes its position in the 2D image as a two-dimensional image, which makes the determination of its position more intuitive, especially at the boundary, the distance between them can be accurately determined, and the area passed by the machine can be determined by the moving path, to facilitate the calculation of the areas, it makes the application scenarios of this system more extensive, such as agricultural spraying, ground mapping, etc.

The basic principles, main features and advantages of the present disclosure have been illustrated and described above. A person skilled in the art should understand that the present disclosure is not limited by the above implementations, and the above implementations and descriptions in the specification are only preferred implementations of the present disclosure and are not intended to limit the present disclosure. without departing from the spirit and scope of the present disclosure, the present disclosure will also have various changes and improvements, and these changes and improvements will fall within the scope of the present disclosure. The scope of protection of the present disclosure is defined by the appended claims and their equivalents.

1. A navigation mapping method for constructing external images of a machine, the method comprising:
obtaining real-time images of a target area;
processing the real-time images and obtaining a two dimensional (2D) image of the target area; and
based on a coverage of the machine in the 2D image, obtaining real-time positions of the machine in the target area.

2. The navigation mapping method for constructing the external images of the machine according to claim 1, wherein,
the acquisition of the real-time images and the real-time positions comprising:
S1: at time T, taking photos facing the target area by covering the target area, so as to obtain a real-time image outside the machine at the time T,
S2: processing the real-time image at the time T to obtain a 2D image,
S3: identifying a coverage of the machine in the 2D image at the time T, and determining a position of the machine in the 2D image at the time T based on the coverage,
S4: after time t, obtaining the following equation: T=T+t, and repeating S1 to S4.

3. The navigation mapping method for constructing the external images of the machine according to claim 2, wherein,
a processing for the real-time images in S2 includes a binarization operation, and the binarization operation comprises:
obtaining a grayscale threshold;
based on the grayscale threshold, determining each pixel point of the real-time image;
if a grayscale value of the pixel point is greater than the grayscale threshold, setting the grayscale value of the pixel point to one (1), and
if the grayscale value of the pixel point is less than the grayscale threshold, setting the grayscale value of the pixel point to zero (0).

4. The navigation mapping method for constructing the external images of the machine according to claim 3, wherein,
in the 2D image, an area with the grayscale value “0” of the pixel point is determined as a machine-walkable area, and
an area with the grayscale value “1” of the pixel point is determined as a machine-unwalkable area.

5. The navigation mapping method for constructing the external images of the machine according to claim 4, wherein,
in S4, recording the position of the machine in the 2D image obtained every time, and establishing a coordinate system, including:
setting a coordinate origin in the 2D image and establishing a coordinate system based on the coordinate origin, and
on the coordinate system, recording coordinates of specific points on the coverage of the machine.

6. The navigation mapping method for constructing the external images of machine according to claim 5, wherein,
speed computing formulas of the machine in the coordinate system are as follows:
$$P ( x , y ) ;$$
$${v}_{x} = \frac{( {x}_{T + t} - {x}_{T} )}{t} ;$$
$${v}_{y} = \frac{( {y}_{T + t} - {y}_{T} )}{t} ,$$
wherein P(x,y) is a coordinate recording in the coordinate system of a specific point, vₓ is a speed on a x-axis of the specific point within a time t, v_{y} is a speed on a y-axis of the specific point within the time t, x_{T+t} is a abscissa of the specific point after the time t, x_{T} is a abscissa of the specific point before the time t, y_{T+t} is a ordinate of the specific point after the time t; y_{T} is a ordinate of the specific point before the time t.

7. The navigation mapping method for constructing the external images of the machine according to claim 2, wherein,
in S1, taking photos of the target area by using one or more cameras, wherein the one or more cameras are set exterior to the machine.

8. The navigation mapping method for constructing the external images of the machine according to claim 7, wherein,
obtaining the real-images by using at least two cameras, and the at least two cameras are mounted at a high point of the target area;
the photographing height of the plurality of cameras are the same;
the plurality of cameras form photographing areas by photographing, and each photographing area comprises at least one other photographing area for forming an intersection area with the photographing area; and
fusing the photographing areas based on the intersection area to obtain the 2D image.

9. The navigation mapping method for constructing the external images of the machine according to claim 7, wherein,
obtaining the real-time images by using at least three cameras, and selecting at least one of the at least three cameras as a high-mounted camera;
a high-mounted photographing area formed by photographing with the high-mounted camera forms an intersection area with other photographing areas respectively, and a combination of the other photographing areas can cover all of the target area; and
fusing the photographing areas based on the intersection area to obtain the 2D image.

10. The navigation mapping method for constructing the external images of the machine according to claim 9, wherein,
fusing the photographing areas according to a multi-view image fusion algorithm, and a formula of the multi-view image fusion algorithm is as follows:
$$[ \begin{matrix}{x}_{i} \\ {y}_{i} \\ 1\end{matrix} ] = F [ \begin{matrix}{x}_{j} \\ {y}_{j} \\ 1\end{matrix} ] ,$$
wherein xᵢ and xⱼ are respectively an abscissa coordinate of a feature point of two photographing areas in the intersection area, yᵢ and yⱼ are respectively an ordinate coordinate of the feature point of the two photographing areas in the intersection area, F is a basic matrix from a photographing area to another photographing area.
